(19) United States
(12) Patent Application Publication
(10) Pub. No.: US 2024/0276292 A1
(43) Pub. Date: Aug. 15, 2024

(54) METHOD, DEVICE, AND SYSTEM FOR CONGESTION CONTROL IN WIRELESS NETWORKS

(71) Applicant: ZTE Corporation, Shenzhen (CN)

(72) Inventors: Zhuang LIU, Shenzhen (CN); Dapeng Li, Shenzhen (CN); He Huang, Shenzhen (CN); Yin Gao, Shenzhen (CN)

(73) Assignee: ZTE Corporation, Shenzhen (CN)

(21) Appl. No.: 18/642,269

(22) Filed: Apr. 22, 2024

Related U.S. Application Data
(63) Continuation of application No. PCT/CN2022/107146, filed on Jul. 21, 2022.

(51) Int. Cl. H04W 28/02; H04W 80/02

(52) U.S. Cl. CPC H04W 28/0284; H04W 28/0268; H04W 28/0289; H04W 80/02

(57) ABSTRACT

This disclosure relates generally to a method, device, and system for congestion control in a wireless network. One method performed by a first network node is disclosed. The method may include determining that a DRB associated with a PDU session of a wireless device is ECN enabled; determining that a congestion occurs in the DRB; and transmitting a first message to at least one of: a second network node, or the wireless device, the first message comprising congestion information of the congestion in the DRB.

### TECHNICAL FIELD

This disclosure is directed generally to wireless communications, and particularly to a method, device, and system for congestion control in a wireless network.

### BACKGROUND

The ecosystem in a wireless communication network includes more and more applications that require low latency, low data loss rate, and high throughput. These applications include Vehicle-to-Vehicle Communication, self-driving, mobile gaming, etc. Efficient and robust congestion control mechanism plays an important role in improving performance of network traffic in the wireless communication network. Under a distributed network architecture, congestion may happen at various network nodes and links between these network nodes. The capability to detect congestion condition in real time at the source of the congestion, and report the congestion condition to relevant network elements for congestion control and mitigation is critical for congestion control.

### SUMMARY

This disclosure is directed to a method, device, and system for congestion control in a wireless network.

In some embodiments, a method performed by a first network node is disclosed. The method may include determining that a Data Radio Bearer (DRB) associated with a Protocol Data Unit (PDU) session of a wireless device is Explicit Congestion Notification (ECN) enabled; determining that a congestion occurs in the DRB; and transmitting a first message to at least one of: a second network node, or the wireless device, the first message comprising congestion information of the congestion in the DRB.

In some embodiments, a method performed by a first network node is disclosed. The method may include: mapping a list of QoS flows to a DRB, each QoS flow in the list of QoS flows being ECN enabled, and the DRB being associated with a PDU session of a wireless device; and receiving, from a second network node, a first message comprising congestion information of a congestion in the DRB.

In some embodiments, there is a network element or a UE comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows exemplary Quality of Service (QOS) flows to Data Radio Bearer (DRB) mapping.

FIG. 5 shows an exemplary implementation for configuring DRB(s) with Explicit Congestion Notification (ECN) related configuration.

FIGS. 6-10 show exemplary implementations and message flows for detecting and handling congestion condition based on ECN.

### DETAILED DESCRIPTION

### Wireless Communication Network

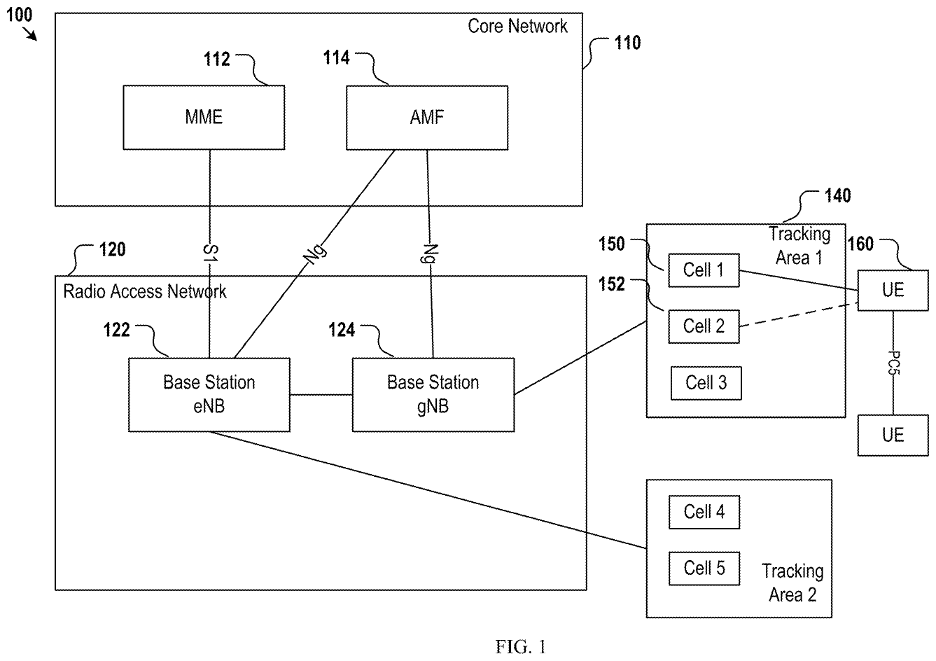

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IOT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

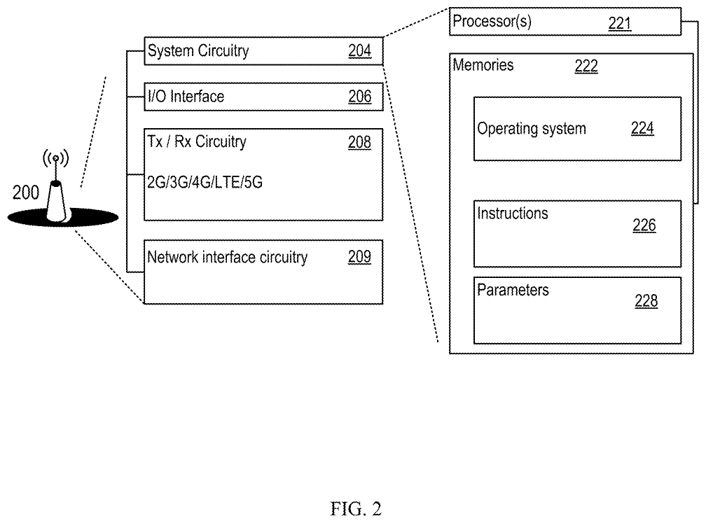

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

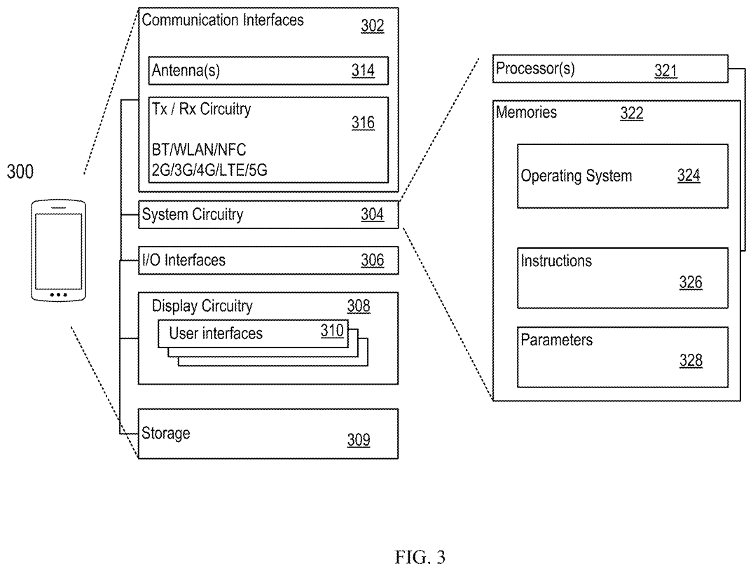

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Explicit Congestion Notification

Explicit Congestion Notification (ECN) is an extension to the Internet Protocol (IP) and the Transmission Control Protocol (TCP). ECN enables end-to-end notification of network congestion without or minimizing dropping packets.

ECN uses two bits of the traffic class field in the IP version 4 (IPv4) or IP version 6 (IPv6) header to encode four different code points. An exemplary code points assignment is listed below as a reference:

00—Non ECN-Capable Transport, Non-ECT (ECN is not supported)
10—ECN Capable Transport, ECT(0) (ECN is supported)
01—ECN Capable Transport, ECT(1) (ECN is supported)

### 11—Congestion Encountered (CE).

In above example, code points “10” (ECT(0)) and “01” (ECT(1)) both indicate that ECN an ECN capable transport.

When a TCP connection is established, ECN negotiation may be performed by two endpoints (e.g., two network nodes). In case the negotiation is successfully performed, if both endpoints support ECN, then each endpoint may mark its packets with ECT(0) or ECT(1), to indicate that ECN is supported.

When a node along the transmission path is experiencing a congestion condition, for IP packets marked with ECT(0) or ECT(1), this node may mark the ECN field in IP header as “congested” (code point “11”) to indicate a congestion condition in the transmission path. Therefore, when the TCP host (or TCP layer) receives the congestion information indicated by the ECN field, congestion control may be performed via the TCP layer.

The congestion condition may be characterized or associated with a direction, which may include an uplink direction, a downlink direction, and a bi-direction (both uplink and downlink direction).

In a wireless network, when a base station detects a congestion, the Packet Data Convergence Protocol (PDCP) layer of the base station may mark ECN field in IP header of IP packets associated with the congested transmission (or congested PDU session) as “congested” (i.e., code point “11”).

A base station, such as a 5G base station (e.g., a gNB), may take a distributed architecture and may be divided into two entities, namely gNB-CU (or CU) and gNB-DU (or DU), either physically, or virtually. The CU may provide support for the higher layers of the protocol stack such as Service Data Adaption Protocol (SDAP), PDCP, and Radio Resource Control (RRC), while the DU may provide support for the lower layers of the protocol stack such as Radio Link Control (RLC), Medium Access Control (MAC), and Physical layer.

When a base station such as a gNB is separated into CU and DU, the PDCP entity layer may be located in the CU entity and is remote to the DU entity. The PDCP entity may not be able to detect in real time whether the transmission queue in the DU is congested, which will cause negative impact for congestion control. For example, either the ECN congestion field in IP header (of IP packet corresponding to the congested transmission) may not be set at all (as the CU may not know the congestion condition in DU), or the ECN congestion field in IP header may be set, but with an intolerable delay. As such, the TCP may not be able to efficiently perform congestion control relying on the ECN filed. Therefore, it is desirable to be able to pass the congestion information from the DU to the CU.

Similarly, a congestion may also happen at UE side. Inefficient and/or inaccurate sharing of congestion information with the base station may also cause similar issues as described above.

Similarly, the Core Network (CN) is also involved with UE traffic transmission. Inefficient and/or inaccurate sharing of congestion information with the CN may also cause similar issues as described above.

In addition, in a Protocol Data Unit (PDU) session, there may be multiple QoS flows mapped to a same Data Radio Bearer (DRB). These QoS flows may have different configurations with respect to ECN capability. For example, some of the QoS flows support ECN (i.e., ECN are enabled for these QoS flows), or it is desirable for some of the QoS flows (e.g., certain types of QoS flows, or QoS flows supporting certain type of applications) to be able to support ECN. On the other hand, other QoS flows do not support or there is no need for them to support ECN. If the DRB contains QoS flows with different ECN support capability, then an ECN based congestion control may not be achieved on a DRB level, at least due to the inconsistent ECN support on the QoS flows within the DRB.

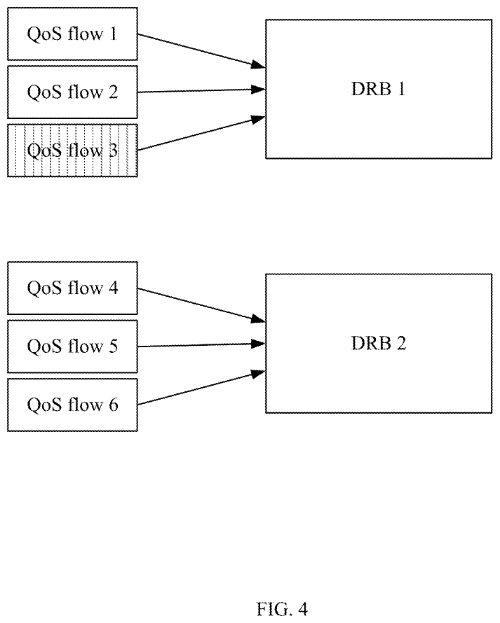

FIG. 4 shows two example QoS flows to DRB mappings. In FIG. 4, QoS flows 1-3 are mapped to DRB 1. Both QoS flows 1-2 support ECN, but QoS flow 3 does not. QoS flows 4-6 are mapped to DRB 2, and all these QoS flows support ECN.

In this disclosure, various embodiments are disclosed, aiming for solving the aforementioned issues. These embodiments cover at least:
Configuring DRB with ECN related configuration, so ECN may be supported at a DRB level;
Detecting congestion at DU, and share the congestion information with various other network elements, such as CU, CN (or CN node), and UE;
Detecting congestion at UE, and share the congestion information with various other network elements, such as DU, CU, and CN (or CN node);
Congestion handling at various network elements, such as DU, CU, CN (or CN node), and UE.

Details on these embodiments are described below.

### Embodiment 1: Configure DRB with ECN Related Configuration

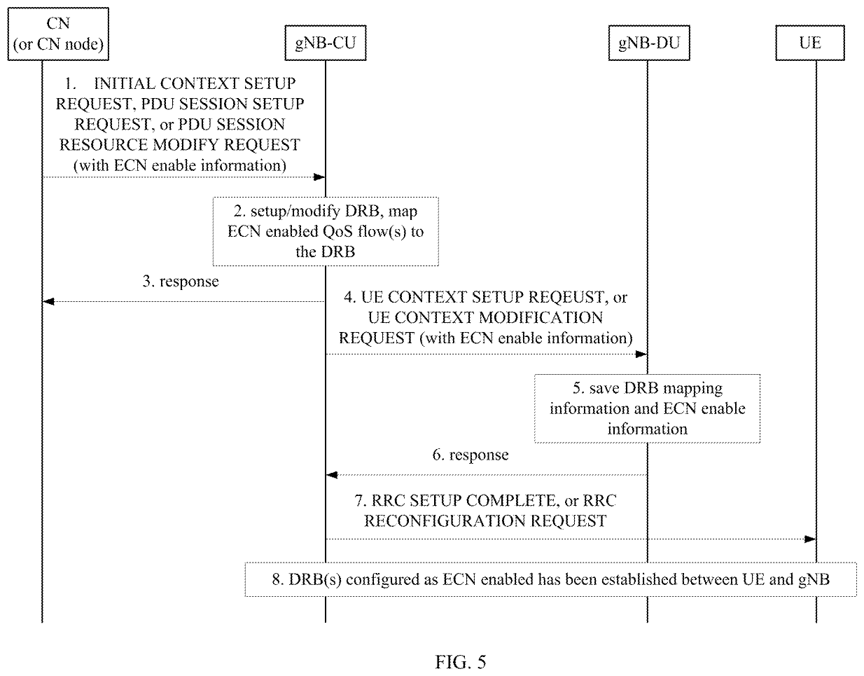

To enable end to end ECN support on a DRB and/or on each QoS flow mapped in the DRB, the DRB may need to be configured with ECN related configuration, such as an indication whether the DRB is ECN-enabled (i.e., whether the DRB support ECN). FIG. 5 illustrates exemplary message flows and interactions among various network elements, including a core network (CN) (or a CN node), a base station (e.g., a gNB) which may further include a CU and a DU, and a UE.

### Step 1

CN may send one of: an initial context setup request message, or a PDU session setup request message to a CU, to request assigning resources for one (or more) PDU session. Alternatively, the CN may send a PDU session resource modify request message to request modifying an existing PDU session (and its associated resources). In these messages, for each QoS flow in a PDU session, the ECN enable information of the QoS flow may be included.

The ECN enable information of the QoS flow may be implicit. For example, a specific 5G QOS Identifier (5QI) value of the QoS flow may implicitly indicates that the QoS flow is ECN enabled. The rule for determining ECN enable information based on 5QI may be pre-defined, or may be signaled by the network.

The ECN enable information of the QoS flow may be explicit. For example, there may be an indicator indicating whether the ECN is enabled for a QoS flow (i.e., the QoS flow supports ECN). In one implementation, the indicator may be part of the QoS parameters associated with the QoS flow.

### Step 2

Upon receiving the requests from the CN, CU needs to setup or modify DRB(s) for the PDU session. CU may map one or more ECN-enabled QoS flow(s) to a same DRB which is configured as ECN enabled. When a DRB is configured with ECN enabled, then all QoS flows mapped in the DRB are ECN-enabled.

### Step 3

CU may send a response message to the CN.

### Step 4

CU may send a UE context setup request message or a UE context modification request message to the DU to request establishing/modifying the UE context including DRB(s). In these messages, ECN enable information of a DRB maybe included.

The ECN enable information of the DRB may be explicit. For example, there may be an indicator indicating whether the ECN is enabled for the DRB. In one implementation, the indicator may be part of the DRB parameters associated with the DRB.

The ECN enable information of the DRB may be implicit. For example, if all QoS flows mapped in the DRB are ECN enabled, then it is indicated that the DRB is ECN enable.

In this disclosure, the CU may host the PDCP entity. In some implementations, the CU may be replaced with any entity (or network node, network element) that hosts the PDCP entity.

In this disclosure, the DU hosts the RLC entity. In some implementations, the DU may be replaced with any entity (or network node, network element) that hosts the RLC entity.

### Step 5

DU may save the mapping information for mapping QoS flows to the DRB, as well as ECN enable information of the DRB.

### Step 6

DU may send a response message to the CU to acknowledge the request message from CU in step 4.

### Step 7

CU may send a Radio Resource Control (RRC) message, for example, an RRC reconfiguration request message, or an RRC setup complete message to UE, to establish or modify the DRB (associated with the PDU session) between UE and the base station. The RRC message may include the ECN enable information of the DRB.

The ECN enable information of the DRB may be explicit. For example, there may be an indicator indicating whether the ECN is enabled for the DRB. In one implementation, the indicator may be part of the DRB parameters associated with the DRB.

The ECN enable information of the DRB may also be implicit. For example, if all QoS flows mapped in the DRB are ECN enabled, then it is indicated that the DRB is ECN enabled.

### Step 8

In this step, a DRB associated with the PDU session is established between UE and the base station, and the DRB is configured as ECN enabled.

### Embodiment 2: Congestion Detection and Handling

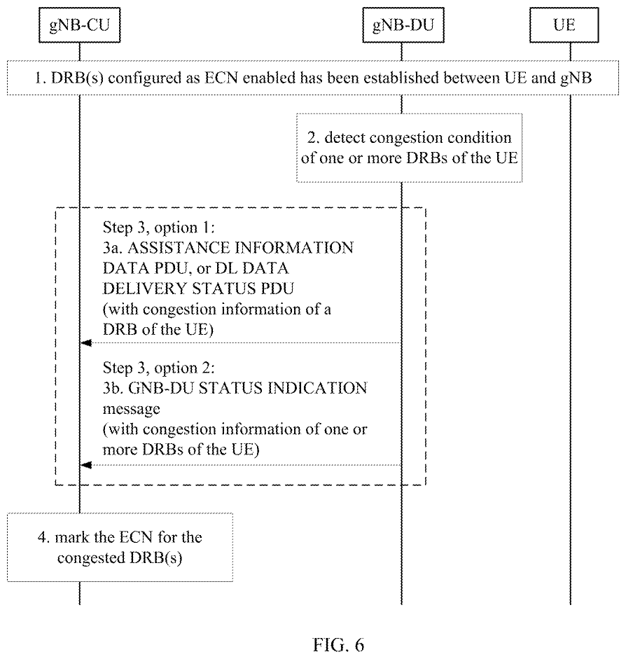

In this embodiment, the DU may detect the congestion condition for a DRB of a UE. FIG. 6 illustrates exemplary message flows and interactions between the DU and the CU.

### Step 1

As a precondition, a DRB configured as ECN enabled has been established between UE and the base station (which includes the CU and the DU).

### Step 2

The DU may detect a congestion condition of the DRB. The congestion may be associated with a particular direction of data transmission. The direction may include: an uplink direction, a downlink direction, or a bi-direction including both an uplink direction and a downlink direction.

In exemplary implementations, in order to reduce resource consumption, for congestion detection purpose, DU may only need to monitor DRB(s) that is configured as ECN enabled.

### Step 3

There may be two options for implementing step 3: step 3a or step 3b.

### Step 3a

This option provides a New Radio User plane (NR-U) solution.

If DU detects there is congestion (downlink, uplink, or bi-direction) condition in at least one DRB of a UE, for each congested DRB of the UE, the DU may construct an NR-U packet, for example, a DL DATA DELIVERY STATUS Protocol Data Unit (PDU), an ASSISTANCE INFORMATION DATA PDU, or the like, to include the congestion information. The congestion information may include at least one of: an indication of whether an uplink congestion occurred in the DRB; an indication of whether a downlink congestion occurred in the DRB; or an indication of whether a bi-direction congestion occurred in the DRB. The DU may then send the NR-U packet to the CU via an NR-U tunnel associated with the congested DRB of the UE, to inform the congestion condition of the DRB.

### Step 3b

This option provides a control plane solution.

If DU detects there is congestion (downlink, uplink, or bi-direction) condition in at least one DRB of a UE, for all congested DRBs, the DU may construct a control plane message, for example, a GNB-DU STATUS INDICATION message, to include the congestion information. The congestion information may include at least one of: a list of UEs (e.g., a list of UE identifiers to identify the UEs); for each identified UE, a list of DRB identifier(s) to identify the congested DRB(s) of the UE; for each congested DRB of the UE, an indication of the direction (i.e., uplink, downlink, or bi-direction) of the congestion condition.

The DU may then send the control plane message (or control plane packet) to the CU, to inform the congestion condition of the DRB.

### Step 4

CU receives the congestion information for a DRB or DRB(s) from the DU, via an NR-U packet or a control plane packet. The CU will proceed to handle the congestion condition for each of the DRB(s). It is to be understood that the congestion information only applies to DRB(s) that is ECN enabled.

For a congested DRB, if the congestion information indicates that the direction of the congestion is uplink, then for each QoS flow mapped in the DRB or associated with the DRB, the CU may set an ECN field in an IP header of an uplink IP packet associated with the each QoS flow as “congested”. The uplink IP packet may be encapsulated in an uplink user plane packet.

Likewise, for a congested DRB, if the congestion information indicates that the direction of the congestion is downlink, then for each QoS flow mapped in the DRB or associated with the DRB, the CU may set an ECN field in an IP header of a downlink IP packet associated with the each QoS flow as “congested”. The downlink IP packet may be encapsulated in a downlink user plane packet.

In the case that the congestion is bi-directional, the CU may set the ECN field in the IP header of the downlink IP packet and in the IP header of the uplink IP packet as “congested”.

### Embodiment 3: Congestion Detection and Handling

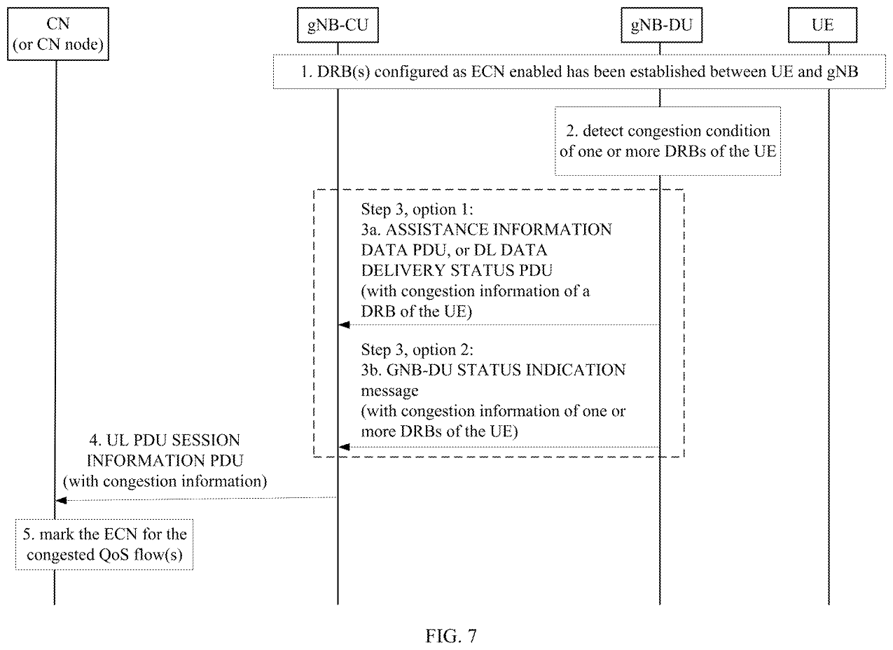

In this embodiment, the DU may detect the congestion condition for a DRB of a UE. FIG. 7 illustrates exemplary message flows and interactions between a DU, a CU, a CN (or CN node), and a UE.

Steps 1-3

Steps 1 to 3 are similar to steps 1 to 3 of embodiment 2 above, so reference may be made in embodiment 2 and the details are skipped herein.

### Step 4

After receiving the congestion information for a DRB or DRB(s) from the DU, via an NR-U packet or a control plane packet, the CU will proceed to handle the congestion condition for each of the DRB(s). It is to be understood that the congestion information only applies to DRB(s) that is ECN enabled.

Each QoS flow mapped in a congested DRB is in congested condition. For each QoS flow mapped in each of the congested DRB, the CU may construct an NG user plane (NG-U) packet, for example, a UL PDU SESSION INFORMATION PDU, or the like, to include the congestion information for the each QoS flow.

The congestion information for the each QoS flow may include at least one of: an indication of whether an uplink congestion occurred in the each QoS flow; an indication of whether a downlink congestion occurred in the each QoS flow; an indication of whether a bi-direction congestion occurred in the each QoS flow; or a QoS flow identifier which is indicative of the each QoS flow (which is in congested condition).

The CU may then send the NG-U packet to the CN (or the CN node). In one implementation, the NG-U packet may be sent via a UE specific NG-U tunnel.

### Step 5

After CN receives the NG-U packet via the UE specific NG-U tunnel, the CN will proceed to handle the congestion condition the congested QoS flow based on the congestion information included in the NG-U packet.

For a congested QoS flow, if the congestion information indicates that the direction of the congestion is uplink, the CN may set an ECN field in an IP header of an uplink IP packet associated with the congested QoS flow as “congested”.

Likewise, for a congested QoS flow, if the congestion information indicates that the direction of the congestion is downlink, the CN may set an ECN field in an IP header of downlink IP packet associated with the congested QoS flow as “congested”.

In the case that the congestion is bi-directional, the CN may set the ECN field in the IP header of the downlink IP packet and in the IP header of the uplink IP packet as “congested”.

### Embodiment 4: Congestion Detection and Handling

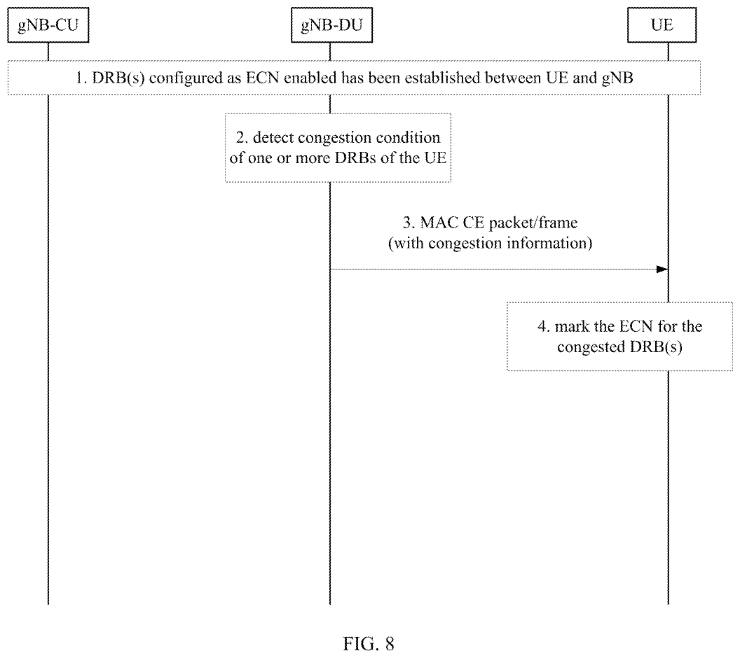

In this embodiment, the DU may detect the congestion condition for a DRB of a UE. FIG. 8 illustrates exemplary message flows and interactions between a DU, a CU, a CN (or CN node), and a UE.

Steps 1 to 2 are similar to steps 1 to 2 of embodiment 2 above, so reference may be made in embodiment 2 and the details are skipped here.

### Step 3

If DU detects there is congestion (downlink, uplink, or bi-direction) condition in at least one DRB of a UE, the DU may construct a Medium Access Control - Control Element (MAC CE) packet, to include the congestion information. The congestion information may include a list of DRB identifiers to identify the congested DRB(s). For each congested DRB, the congestion information may further include at least one of: an indication of whether an uplink congestion occurred in the DRB; an indication of whether a downlink congestion occurred in the DRB; or an indication of whether a bi-direction congestion occurred in the DRB.

The DU may then send the MAC CE packet to the UE.

### Step 4

After receiving the congestion information for a DRB or DRB(s) from the DU, via the MAC CE packet, the UE will proceed to handle the congestion condition for each of the DRB(s). It is to be understood that the congestion information only applies to DRB(s) that is ECN enabled.

For a congested DRB, if the congestion information indicates that the direction of the congestion is uplink, for each QoS flow mapped in the DRB or associated with the DRB, the CU may set an ECN field in an IP header of an uplink IP packet associated with the each QoS flow as “congested”. The uplink IP packet may be encapsulated in an uplink user plane packet.

Likewise, for a congested DRB, if the congestion information indicates that the direction of the congestion is downlink, for each QoS flow mapped in the DRB or associated with the DRB, the CU may set an ECN field in an IP header of a downlink IP packet associated with the each QoS flow as “congested”. The downlink IP packet may be sent to an application (running in the UE).

In the case that the congestion is bi-directional, the CU may set the ECN field in the IP header of the downlink IP packet and the in IP header of the uplink IP packet as “congested”.

### Embodiment 5: Congestion Detection and Handling

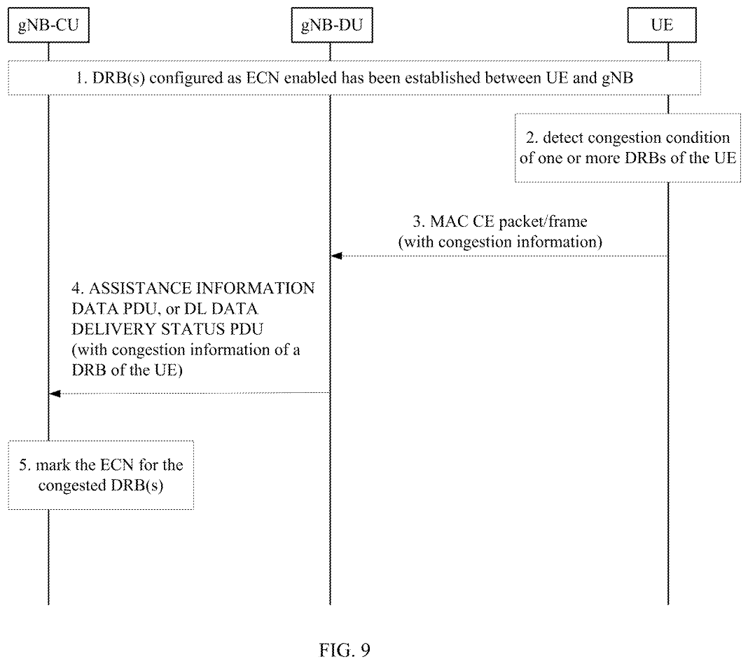

In this embodiment, the UE may detect the congestion condition for a DRB of a UE. FIG. 9 illustrates exemplary message flows and interactions between the UE, the DU and the CU.

### Step 1

As a precondition, a DRB configured as ECN enabled has been established between UE and the base station (which includes the CU and the DU).

### Step 2

If UE detects there is congestion (downlink, uplink, or bi-direction) condition in at least one DRB of the UE, the UE may construct a MAC CE packet, to include the congestion information. The congestion information may include a list of DRB identifiers to identify the congested DRB(s). For each congested DRB, the congestion information may further include at least one of: an indication of whether an uplink congestion occurred in the DRB; an indication of whether a downlink congestion occurred in the DRB; or an indication of whether a bi-direction congestion occurred in the DRB.

### Step 3

The UE may then send the MAC CE packet to the DU.

In some example implementations, the UE may send the MAC CE packet to RAN, or a node in the RAN.

### Step 4

The DU (or the RAN, the node in the RAN) receives the MAC CE packet from the UE, which includes the congestion Information as described in step 3 above.

Based on the congestion information sent from the UE, and for each congested DRB of the UE, the DU may construct an NR-U packet, for example, a DL DATA DELIVERY STATUS PDU, an ASSISTANCE INFORMATION DATA PDU, or the like, to include the congestion information. The congestion information may include at least one of: an indication of whether an uplink congestion occurred in the DRB; an indication of whether a downlink congestion occurred in the DRB; or an indication of whether a bi-direction congestion occurred in the DRB.

The DU may then send the NR-U packet to the CU via an NR-U tunnel associated with the congested DRB of the UE, to inform the congestion condition of the DRB. Therefore, the congestion initiated from the UE is forwarded by the DU to the CU.

### Step 5

Step 5 in this embodiment is similar to step 4 in embodiment 2. Details may be referred back to embodiment 2 and are skipped herein.

### Embodiment 6: Congestion Detection and Handling

In this embodiment, the UE may detect the congestion condition for a DRB of a UE.

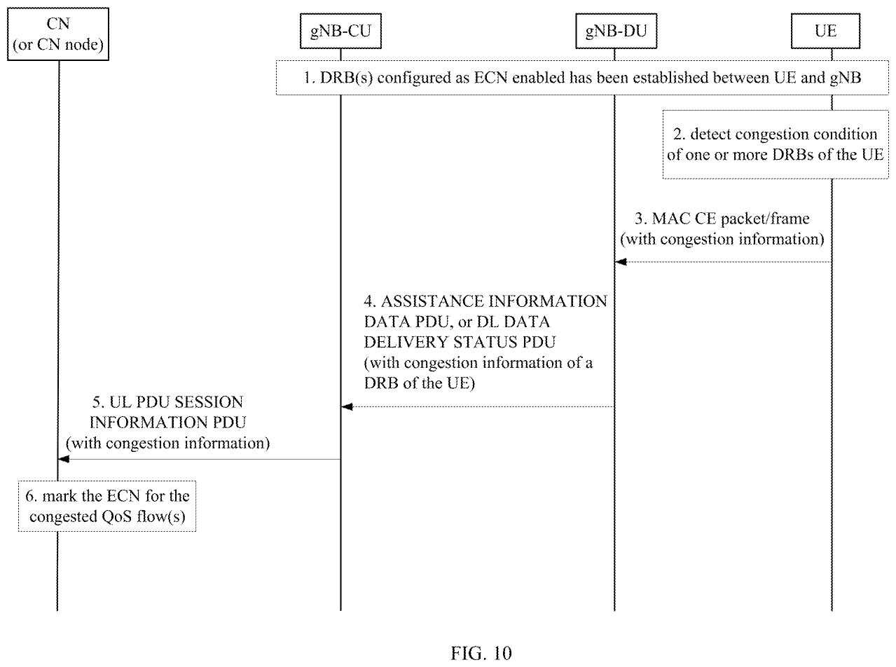

FIG. 10 illustrates exemplary message flows and interactions between the UE, the DU, the CU, and the CN (or CN node).

Steps 1-4

Steps 1-4 are similar to steps 1-4 in embodiment 5. Details may be referred back to embodiment 5 and are skipped herein.

### Step 5

In step 5, CU forward congestion information to the CN. Step 5 is similar to step 4 in embodiment 3. Details may be referred back to embodiment 3 and are skipped herein.

### Step 6

Step 6 is similar to step 5 in embodiment 3. Details may be referred back to embodiment 3 and are skipped herein.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a first network node, the method comprising:
determining that a Data Radio Bearer (DRB) associated with a Protocol Data Unit (PDU) session of a wireless device is Explicit Congestion Notification (ECN) enabled;
determining that a congestion occurs in the DRB; and
transmitting a first message to at least one of: a second network node, or the wireless device, the first message comprising congestion information of the congestion in the DRB.

2. The method of claim 1, wherein:
the first network node comprises a Distributed Unit (DU) of a gNodeB (gNB); and
the second network node comprises a Central Unit (CU) of the gNB.

3. The method of claim 1, wherein:
the first network node hosts a Radio Link Control (RLC) entity of a base station; and
the second network node hosts a Packet Data Convergence Protocol (PDCP) entity of the base station.

4. The method of claim 1, wherein the congestion information is used by the second network node or the wireless device for congestion control on the DRB, and wherein the congestion information comprises an indication of a direction of the congestion in the DRB, the direction comprising an uplink direction, and a downlink direction.

5. (canceled)

6. The method of claim 1, wherein determining that the DRB is ECN enabled comprising at least one of:
receiving a second message from the second network node, the second message comprising an indicator indicating that the DRB is ECN enabled, and determining that the DRB is ECN enabled based on the indicator; or
in response to all Quality of Service (QOS) flows in the DRB being ECN enabled, determining that the DRB is ECN enabled.

7. (canceled)

8. The method of claim 6, further comprising:
receiving a third message from the second network node, the third message being indicative of all the QoS flows in the DRB are ECN enabled.

9. The method of claim 1, wherein:
the first message comprises an NR-U packet; and
transmitting the first message comprises transmitting the first message to the second network node via an NR-U tunnel associated with the DRB.

10. The method of claim 1, wherein transmitting the first message comprises transmitting the first message to the second network node via at least one of:
a downlink data delivery status PDU; or
an assistance information data PDU.

11. The method of claim 1, wherein: the first message comprises a control plane message, the control plane message comprising a GNB-DU STATUS INDICATION message; and
the congestion information comprising at least one of:
a list of wireless devices, the wireless device being a member of the list of wireless devices;
for each wireless device in the list of wireless devices, a list of DRBs under congestion condition;
for each DRB in the list of DRBs, an indication that an uplink congestion occurs in the each DRB; or
for the each DRB in the list of DRBs, an indication that a downlink congestion occurs in the each DRB.

12. (canceled)

13. The method of claim 1, wherein a reception of the first message on the second network node triggers the second network node to:
determine a direction of the congestion in the DRB, the direction comprising an uplink direction and a downlink direction; and
for each QoS flow mapped to the DRB, and based on the direction of the congestion in the DRB, set an ECN field in an Internet Protocol (IP) header of an IP packet associated with the each QoS flow to indicate that a congestion occurs in the each QoS flow, wherein: the IP packet is encapsulated in a user plane packet; the user plane packet comprises one of an uplink user plane packet and a downlink user plane packet; and a direction of the user plane packet being indicated by the direction of the congestion in the DRB.

14. The method of claim 1, wherein:
the first message comprises a Medium Access Control—Control Element (MAC CE) message; and
the MAC CE message comprises at least one of:
a list of DRBs under congestion condition, the DRB being a member of the list of DRB;
for each DRB in the list of DRBs, an indication that an uplink congestion occurs in the each DRB; or
for the each DRB in the list of DRBs, an indication that a downlink congestion occurs in the each DRB.

15. The method of claim 1, wherein a reception of the first message on the wireless device triggers the wireless device to:
determine a direction of the congestion in the DRB, the direction comprising an uplink direction and a downlink direction; and
for each QoS flow mapped to the DRB, and based on the direction of the congestion in the DRB, set an ECN field in an IP header of an IP packet associated with the each QoS flow to indicate that a congestion occurs in the each QoS flow, wherein: the IP packet is encapsulated in a user plane packet; the user plane packet comprises one of an uplink user plane packet and a downlink user plane packet; and a direction of the user plane packet being indicated by the direction of the congestion in the DRB.

16. The method of claim 1, wherein determining that the congestion occurs in the DRB comprises:
receiving a fourth message from the wireless device, the fourth message indicating that the congestion occurs in the DRB.

17. The method of claim 16, wherein:
the fourth message comprises a MAC CE message; and
the MAC CE message comprises at least one of:
a first indicator indicating that the congestion occurs in the DRB; or
a second indicator indicating a direction of the congestion in the DRB.

18-37. (canceled)

38. A first network node comprising a memory for storing computer instructions and a processor in communication with the memory, wherein, when the processor executes the computer instructions, the processor is configured to cause the first network node to:
determine that a Data Radio Bearer (DRB) associated with a Protocol Data Unit (PDU) session of a wireless device is Explicit Congestion Notification (ECN) enabled;
determine that a congestion occurs in the DRB; and
transmit a first message to at least one of: a second network node, or the wireless device, the first message comprising congestion information of the congestion in the DRB.

39. The first network node of claim 38, wherein:
the first network node comprises a Distributed Unit (DU) of a gNodeB (gNB); and
the second network node comprises a Central Unit (CU) of the gNB.

40. The first network node of claim 38, wherein:
the first network node hosts a Radio Link Control (RLC) entity of a base station; and
the second network node hosts a Packet Data Convergence Protocol (PDCP) entity of the base station.

41. The first network node of claim 38, wherein the congestion information is used by the second network node or the wireless device for congestion control on the DRB, and wherein the congestion information comprises an indication of a direction of the congestion in the DRB, the direction comprising an uplink direction, and a downlink direction.

42. The first network node of claim 38, wherein, when the processor is configured to cause the first network node to determine that the DRB is ECN enabled, the processor is configured to cause the first network node to perform one of:
receiving a second message from the second network node, the second message comprising an indicator indicating that the DRB is ECN enabled, and determining that the DRB is ECN enabled based on the indicator; or
in response to all Quality of Service (QOS) flows in the DRB being ECN enabled, determining that the DRB is ECN enabled.

43. A non-transitory storage medium for storing computer readable instructions, the computer readable instructions, when executed by a processor in a first network node, causing the processor to:
determine that a Data Radio Bearer (DRB) associated with a Protocol Data Unit (PDU) session of a wireless device is Explicit Congestion Notification (ECN) enabled;
determine that a congestion occurs in the DRB; and
transmit a first message to at least one of: a second network node, or the wireless device. the first message comprising congestion information of the congestion in the DRB.
